(19) United States
(12) Patent Application Publication
(10) Pub. No.: US 2025/0292711 A1
(43) Pub. Date: Sep. 18, 2025

(54) DISPLAY APPARATUS AND METHOD OF DRIVING DISPLAY PANEL USING THE SAME

(71) Applicant: Samsung Display Co., LTD., Yongin-si (KR)

(72) Inventors: YOONJU KIM, Yongin-si (KR); BONGGYUN KANG, Yongin-si (KR); JAE WOO RYU, Yongin-si (KR)

(21) Appl. No.: 18/980,768

(22) Filed: Dec. 13, 2024

(30) Foreign Application Priority Data
Mar. 13, 2024 (KR) 10-2024-0035085

(51) Int. Cl. G09G 3/00; G09G 3/3225; G09G 3/3266

(52) U.S. Cl. CPC G09G 3/006; G09G 3/3225; G09G 3/3266; G09G 2300/0842; G09G 2330/02; G09G 2330/12

(57) ABSTRACT

A display apparatus includes a display panel including first and second display areas, a first gate driver configured to output a first gate signal to the first display area, a first data driver configured to output a first data voltage to the first display area, a first driving controller configured to control the first gate driver and the first data driver, a second gate driver configured to output a second gate signal to the second display area, a second data driver configured to output a second data voltage to the second display area, and a second driving controller configured to control the second gate driver and the second data driver, wherein at least one of the first or second driving controllers is configured to compare input data and sensed data, and to generate a shutdown signal based on a comparison result of the input data and the sensed data.

### CROSS-REFERENCE TO RELATED APPLICATION

The present application claims priority to, and the benefit of, Korean Patent Application No. 10-2024-0035085, filed on Mar. 13, 2024, in the Korean Intellectual Property Office, the entire disclosure of which is incorporated herein by reference.

### BACKGROUND

### 1. Field

Embodiments of the present disclosure relate to a display apparatus including a plurality of driving controllers and monitoring a display image abnormality, and a method of driving the display panel using the display apparatus.

### 2. Description of the Related Art

Generally, a display apparatus includes a display panel and a display panel driver. The display panel displays an image based on input image data. The display panel includes a plurality of gate lines, a plurality of data lines and a plurality of pixels. The display panel driver includes a gate driver, a data driver, and a driving controller. The gate driver outputs gate signals to the gate lines. The data driver outputs data voltages to the data lines. The driving controller controls an operation of the gate driver and an operation of the data driver.

Recently, a demand for high performance display apparatuses having a high resolution and a high frequency is increasing. However, a performance of a driving controller for driving the high performance display apparatus is limited so that the display apparatus may include a plurality of driving controllers to drive the high performance display apparatus. When the display apparatus includes the plurality of driving controllers and a malfunction occurs in one of the plurality of driving controllers, a display image abnormality may occur. Due to the image abnormality, a reliability of the display apparatus may be decreased.

### SUMMARY

Embodiments of the present disclosure provide a display apparatus including a plurality of driving controllers and monitoring a display image abnormality to enhance a reliability of the display apparatus.

Embodiments of the present disclosure also provide a method of driving a display panel using the display apparatus.

In one or more embodiments of a display apparatus according to the present disclosure, the display apparatus includes a display panel including a first display area and a second display area, a first gate driver configured to output a first gate signal to the first display area, a first data driver configured to output a first data voltage to the first display area, a first driving controller configured to control the first gate driver and the first data driver, a second gate driver configured to output a second gate signal to the second display area, a second data driver configured to output a second data voltage to the second display area, and a second driving controller configured to control the second gate driver and the second data driver, wherein at least one of the first driving controller or the second driving controller is configured to compare input data and sensed data, and to generate a shutdown signal based on a comparison result of the input data and the sensed data.

The sensed data may correspond to an anode electrode of a light-emitting element of a pixel of the display panel.

The pixel may include a first thin film transistor configured to apply a first

power voltage to a second node in response to a signal of a first node, a second thin film transistor configured to output a data voltage to the first node in response to a first signal, a third thin film transistor configured to output a signal of the second node to a sensing node in response to a second signal, a storage capacitor including a first end portion coupled to the first node, and a second end portion coupled to the second node, and the light-emitting element including the anode electrode coupled to the second node, and a cathode electrode configured to receive a second power voltage.

The second driving controller may be configured to output second input data of the second display area to the first driving controller.

The first driving controller may include an input data processor configured to simplify the input data to generate simplified input data, a sensed data processor configured to simplify the sensed data to generate simplified sensed data, a comparator configured to compare the simplified input data and the simplified sensed data, and a shutdown controller configured to generate the shutdown signal based on a comparison result of the simplified input data and the simplified sensed data.

At least one of the input data processor or the sensed data processor may be configured to perform data conversion to unify formats of the input data and the sensed data.

The shutdown controller may be configured to determine whether a number of pixels, in which a difference between the simplified input data and the simplified sensed data is equal to or greater than a threshold value, is equal to or greater than a threshold pixel number for an N-th horizontal line, N being a positive integer.

The shutdown controller may be configured to determine the N-th horizontal line as an error line when the number of the pixels is equal to or greater than the threshold pixel number for the N-th horizontal line, wherein the shutdown signal is configured to be activated when a number of the error lines is equal to or greater than a threshold line number.

The shutdown controller may be configured to determine the N-th horizontal line as an error line when the number of the pixels is equal to or greater than the threshold pixel number for the N-th horizontal line, wherein the shutdown signal is configured to be activated when a number of frames in which the N-th horizontal line is determined as the error line is equal to or greater than a threshold frame number.

The shutdown controller may be configured to determine the N-th horizontal line as an error line when the number of the pixels is equal to or greater than the threshold pixel number for the N-th horizontal line, wherein the shutdown signal is configured to be activated when a number of frames, in which a number of the error lines is equal to or greater than a threshold line number, is equal to or greater than a threshold frame number.

The sensed data may be configured to be generated in a unit of a horizontal line, wherein the sensed data are configured to be sensed from an upper end portion of the display panel or from a lower end portion of the display panel.

The display apparatus may further include a power voltage generator configured to output a first power voltage to the display panel, wherein the power voltage generator is configured not to output the first power voltage, or is configured to change a level of the first power voltage, based on receiving the shutdown signal that is activated.

The first driving controller may include a first input data processor configured to simplify first input data of the first display area to generate first simplified input data, a first sensed data processor configured to simplify first sensed data of the first display area to generate first simplified sensed data, a first comparator configured to compare the first simplified input data and the first simplified sensed data, and a first shutdown controller configured to generate a first shutdown signal based on a comparison result of the first simplified input data and the first simplified sensed data.

The second driving controller may include a second input data processor configured to simplify second input data of the second display area to generate second simplified input data, a second sensed data processor configured to simplify second sensed data of the second display area to generate second simplified sensed data, a second comparator configured to compare the second simplified input data and the second simplified sensed data, and a second shutdown controller configured to generate a second shutdown signal based on a comparison result of the second simplified input data and the second simplified sensed data.

The display apparatus may further include a power voltage generator configured to output a first power voltage to the display panel, wherein the power voltage generator is configured not to output the first power voltage, or is configured to change a level of the first power voltage, based on receiving at least one of the first shutdown signal that is activated or the second shutdown signal that is activated.

In one or more embodiments of a method of driving a display panel according to the present disclosure, the method includes outputting a first gate signal to a first display area of the display panel, outputting a first data voltage to the first display area, outputting a second gate signal to a second display area of the display panel, outputting a second data voltage to the second display area, sensing output data of the display panel, comparing input data and sensed data using at least one of a first driving controller controlling driving of the first display area or a second driving controller controlling driving of the second display area, and generating a shutdown signal based on a comparison result of the input data and the sensed data.

The method may further include simplifying the input data to generate simplified input data, simplifying the sensed data to generate simplified sensed data, comparing the simplified input data and the simplified sensed data, and generating the shutdown signal based on a comparison result of the simplified input data and the simplified sensed data.

Comparing the input data and the sensed data may include determining whether a number of pixels, in which a difference between the simplified input data and the simplified sensed data is equal to or greater than a threshold value, is equal to or greater than a threshold pixel number for an N-th horizontal line, N being a positive integer.

The method may further include determining the N-th horizontal line as an error line when the number of the pixels is equal to or greater than the threshold pixel number for the N-th horizontal line, and activating the shutdown signal when a number of the error lines is equal to or greater than a threshold line number.

The method may further include determining the N-th horizontal line as an error line when the number of the pixels is equal to or greater than the threshold pixel number for the N-th horizontal line, and activating the shutdown signal when a number of frames in which the N-th horizontal line is determined as the error line is equal to or greater than a threshold frame number.

In one or more embodiments of an electronic device according to the present disclosure, the electronic device includes a display apparatus including a display panel including a first display area and a second display area, a first gate driver configured to output a first gate signal to the first display area, a first data driver configured to output a first data voltage to the first display area, a first driving controller configured to control the first gate driver and the first data driver, a second gate driver configured to output a second gate signal to the second display area, a second data driver configured to output a second data voltage to the second display area, and a second driving controller configured to control the second gate driver and the second data driver, wherein at least one of the first driving controller or the second driving controller is configured to compare input data and sensed data, and to generate a shutdown signal based on a comparison result of the input data and the sensed data.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

According to the display apparatus and the method of driving the display panel, the display image abnormality may be properly monitored by comparing the input data and the sensed data in the display apparatus including the plurality of driving controllers.

When the display image abnormality occurs in the display apparatus including the plurality of driving controllers, the image display of the display panel may be stopped, so that the reliability of the display apparatus may be enhanced.

### BRIEF DESCRIPTION OF THE DRAWINGS

The above and other aspects of the present disclosure will become more apparent by describing in detailed embodiments thereof with reference to the accompanying drawings, in which:

FIG. 1 is a block diagram illustrating a display apparatus according to one or more embodiments of the present disclosure;

FIG. 2 is a circuit diagram illustrating a first pixel of FIG. 1;

FIG. 3 is a block diagram illustrating a first driving controller of FIG. 1;

FIG. 4 is a flowchart illustrating an operation of the first driving controller of FIG. 1;

FIG. 5 is a diagram illustrating a case in which a luminance change error occurs in a display panel of FIG. 1;

FIG. 6 is a diagram illustrating simplified input data and simplified sensed data generated by the first driving controller of FIG. 3 in the case of FIG. 5;

FIG. 7 is a diagram illustrating a case in which a vertical shift error occurs in the display panel of FIG. 1;

FIG. 8 is a diagram illustrating simplified input data and simplified sensed data generated by the first driving controller of FIG. 3 in the case of FIG. 7;

FIG. 9 is a diagram illustrating a case in which a horizontal shift error occurs in the display panel of FIG. 1;

FIG. 10 is a diagram illustrating simplified input data and simplified sensed data generated by the first driving controller of FIG. 3 in the case of FIG. 9;

FIG. 11 is a diagram illustrating a case in which an error does not occur in the display panel of FIG. 1;

FIG. 12 is a diagram illustrating simplified input data and simplified sensed data generated by the first driving controller of FIG. 3 in the case of FIG. 11;

FIG. 13 is a block diagram illustrating a display apparatus according to one or more embodiments of the present disclosure;

FIG. 14 is a block diagram illustrating a first driving controller of FIG. 13;

FIG. 15 is a block diagram illustrating a second driving controller of FIG. 13;

FIG. 16 is a block diagram illustrating an electronic apparatus according to one or more embodiments of the present disclosure; and

FIG. 17 is a diagram illustrating an example in which the electronic apparatus of FIG. 16 is implemented as a smartphone.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection.

For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

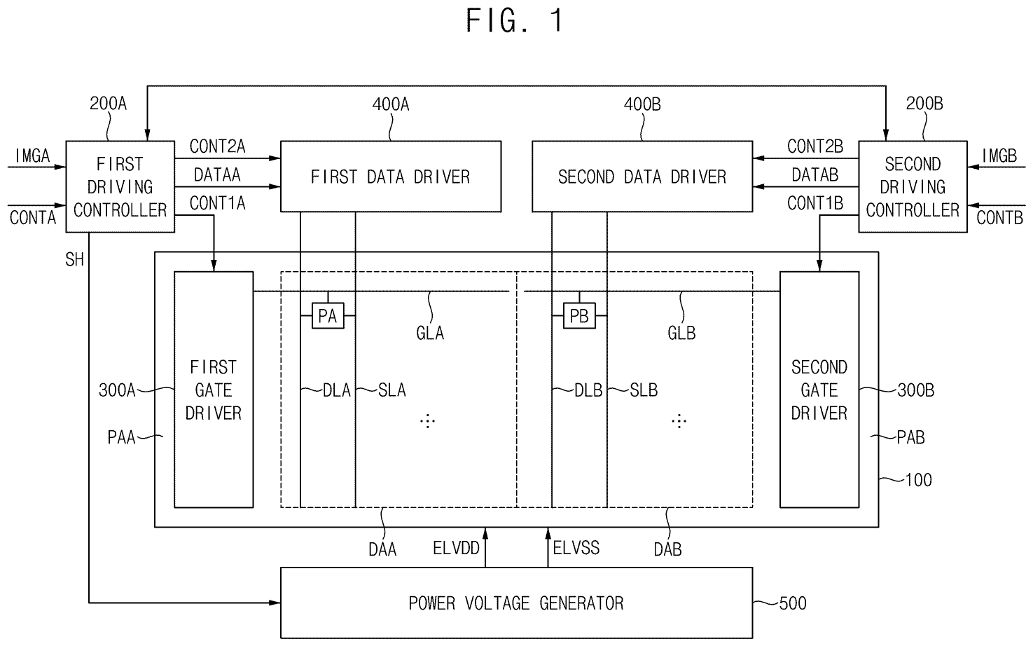

FIG. 1 is a block diagram illustrating a display apparatus according to one or more embodiments of the present disclosure.

Referring to FIG. 1, the display apparatus includes a display panel 100 and a display panel driver. The display panel driver drives the display panel 100. The display panel driver includes a first driving controller 200A, a first gate driver 300A, a first data driver 400A, a second driving controller 200B, a second gate driver 300B, a second data driver 400B, and a power voltage generator 500.

The display panel 100 includes a plurality of display areas (e.g., a first display area DAA and a second display area DAB).

The display panel driver includes a plurality of driving controllers (e.g., the first driving controller 200A and the second driving controller 200B). The first driving controller 200A and the second driving controller 200B may be independently formed.

The display panel driver includes a plurality of gate drivers (e.g., the first gate driver 300A and the second gate driver 300B). The first gate driver 300A outputs a first gate signal to a first gate line GLA of the first display area DAA. The second gate driver 300B outputs a second gate signal to a second gate line GLB of the second display area DAB. The first gate line GLA may not be connected to the second gate line GLB. The first gate driver 300A and the second gate driver 300B may be independently formed.

The display panel driver includes a plurality of data drivers (e.g., the first data driver 400A and the second data driver 400B). The first data driver 400A outputs a first data voltage to a first data line DLA of the first display area DAA. The second data driver 400B outputs a second data voltage to a second data line DLB of the second display area DAB. The first data driver 400A and the second data driver 400B may be independently formed. Alternatively, the first data driver 400A and the second data driver 400B may be integrally formed.

For example, the first driving controller 200A and the first data driver 400A may be integrally formed. A driving module including at least the first driving controller 200A and the first data driver 400A, which may be integrally formed, may be referred to as a first timing-controller-embedded data driver (TED).

Similarly, the second driving controller 200B and the second data driver 400B may be integrally formed. A driving module including at least the second driving controller 200B and the second data driver 400B, which are integrally formed may be referred to as a second timing-controller-embedded data driver (TED).

The display panel 100 has a display region DAA and DAB on which an image is displayed, and a peripheral region PAA and PAB adjacent to the display region DAA and DAB.

The first display area DAA of the display panel 100 includes a plurality of first gate lines GLA, a plurality of first data lines DLA, and a plurality of first pixels PA connected to the first gate lines GLA and to the first data lines DLA. The first gate lines GLA may extend in a first direction D1, and the first data lines DLA may extend in a second direction D2 crossing the first direction D1.

The first data driver 400A may receive first sensed data from the first pixels PA. The first data driver 400A may receive the first sensed data from the first pixels PA through first sensing lines SLA. The first sensing lines SLA may extend in the second direction D2.

The second display area DAB of the display panel 100 includes a plurality of second gate lines GLB, a plurality of second data lines DLB, and a plurality of second pixels PB connected to the second gate lines GLB and to the second data lines DLB. The second gate lines GLB may extend in the first direction D1, and the second data lines DLB may extend in the second direction D2.

The second data driver 400B may receive second sensed data from the second pixels PB. The second data driver 400B may receive the second sensed data from the second pixels PB through second sensing lines SLB. The second sensing lines SLB may extend in the second direction D2.

The first driving controller 200A receives first input image data IMGA and a

first input control signal CONTA, which correspond to the first display area DAA from an external apparatus (e.g. an application processor). For example, the first input image data IMGA may include red image data, green image data, and blue image data. For example, the first input image data IMGA may include white image data. For example, the first input image data IMGA may include magenta image data, yellow image data, and cyan image data. The first input control signal CONTA may include a master clock signal and a data enable signal. The first input control signal CONTA may further include a vertical synchronizing signal and a horizontal synchronizing signal.

The first driving controller 200A generates a 1-1 control signal CONT1A, a 1-2 control signal CONT2A, and a first data signal DATAA based on the first input image data IMGA and the first input control signal CONTA.

The first driving controller 200A generates the 1-1 control signal CONT1A for controlling an operation of the first gate driver 300A based on the first input control 1 signal CONTA, and outputs the 1-1 control signal CONT1A to the first gate driver 300A. The 1-1 control signal CONT1A may include a vertical start signal and a gate clock signal.

The first driving controller 200A generates the 1-2 control signal CONT2A for controlling an operation of the first data driver 400A based on the first input control signal CONTA, and outputs the 1-2 control signal CONT2A to the first data driver 400A. The 1-2 control signal CONT2A may include a horizontal start signal and a load signal.

The first driving controller 200A generates the first data signal DATAA based on the first input image data IMGA. The first driving controller 200A outputs the first data signal DATAA to the first data driver 400A.

The second driving controller 200B receives second input image data IMGB and a second input control signal CONTB, which correspond to the second display area DAB from the external apparatus (e.g. the application processor). For example, the second input image data IMGB may include red image data, green image data, and blue image data. For example, the second input image data IMGB may include white image data. For example, the second input image data IMGB may include magenta image data, yellow image data, and cyan image data. The second input control signal CONTB may include a master clock signal and a data enable signal. The second input control signal CONTB may further include a vertical synchronizing signal and a horizontal synchronizing signal.

The second driving controller 200B generates a 2-1 control signal CONT1B, a 2-2 control signal CONT2B, and a second data signal DATAB based on the second input image data IMGB and the second input control signal CONTB.

The second driving controller 200B generates the 2-1 control signal CONT1B for controlling an operation of the second gate driver 300B based on the second input control signal CONTB, and outputs the 2-1 control signal CONT1B to the second gate driver 300B. The 2-1 control signal CONT1B may include a vertical start signal and a gate clock signal.

The second driving controller 200B generates the 2-2 control signal CONT2B for controlling an operation of the second data driver 400B based on the second input control signal CONTB, and outputs the 2-2 control signal CONT2B to the second data driver 400B. The 2-2 control signal CONT2B may include a horizontal start signal and a load signal.

The second driving controller 200B generates the second data signal DATAB based on the second input image data IMGB. The second driving controller 200B outputs the second data signal DATAB to the second data driver 400B.

The first gate driver 300A generates first gate signals for driving the first gate lines GLA in response to the 1-1 control signal CONT1A received from the first driving controller 200A. The first gate driver 300A outputs the first gate signals to the first gate lines GLA. For example, the first gate driver 300A may sequentially output the first gate signals to the first gate lines GLA. For example, the first gate driver 300A may be mounted on the first peripheral region PAA of the display panel 100. For example, the first gate driver 300A may be integrated on the first peripheral region PAA of the display panel 100.

The first data driver 400A receives the 1-2 control signal CONT2A and the first data signal DATAA from the first driving controller 200A. The first data driver 400A converts the first data signal DATAA into first data voltages having an analog type. The first data driver 400A outputs the first data voltages to the first data lines DLA.

The second gate driver 300B generates second gate signals driving the second gate lines GLB in response to the 2-1 control signal CONT1B received from the second driving controller 200B. The second gate driver 300B outputs the second gate signals to the second gate lines GLB. For example, the second gate driver 300B may sequentially output the second gate signals to the second gate lines GLB. For example, the second gate driver 300B may be mounted on the second peripheral region PAB of the display panel 100. For example, the second gate driver 300B may be integrated on the second peripheral region PAB of the display panel 100.

The second data driver 400B receives the 2-2 control signal CONT2B and the second data signal DATAB from the second driving controller 200B. The second data driver 400B converts the second data signal DATAB into second data voltages having an analog type. The second data driver 400B outputs the second data voltages to the second data lines DLB.

The power voltage generator 500 may generate a first power voltage ELVDD of the display panel 100 and a second power voltage ELVSS of the display panel 100. The power voltage generator 500 may output the first power voltage ELVDD of the display panel 100 and the second power voltage ELVSS of the display panel 100 to the display panel 100. Although the display apparatus includes the one power voltage generator 500, the present disclosure may not be limited thereto. Alternatively, the display apparatus may include a first power voltage generator for outputting the first power voltage ELVDD and the second power voltage ELVSS to the first display area DAA, and may include a second power voltage generator for outputting the first power voltage ELVDD and the second power voltage ELVSS to the second display area DAB.

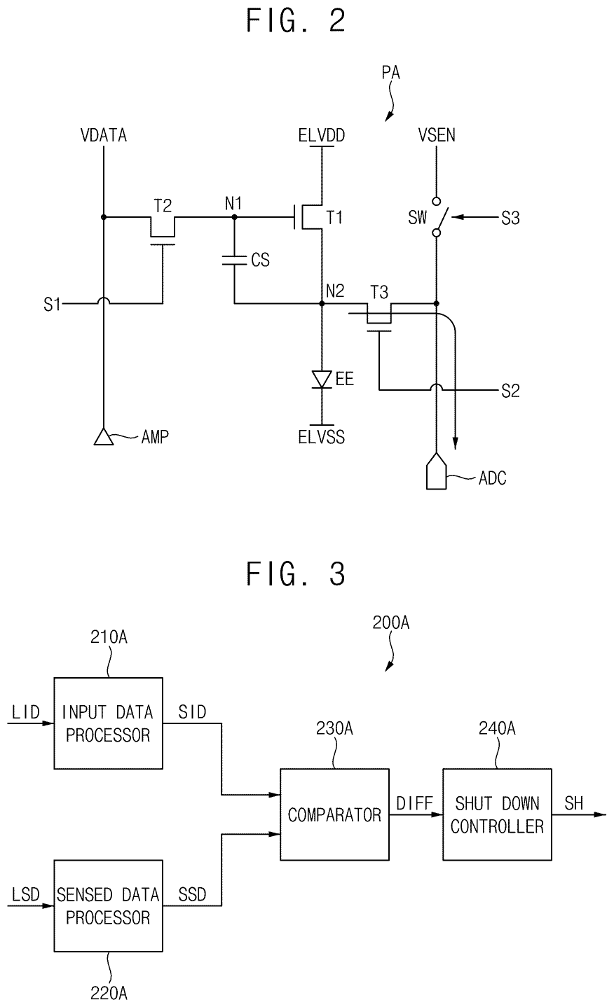

FIG. 2 is a circuit diagram illustrating a first pixel PA of FIG. 1.

Referring to FIGS. 1 and 2, the sensed data may be received from anode electrodes of light-emitting elements EE of the pixels PA and PB of the display panel 100. For example, first sensed data of the first display area DAA may be received from the anode electrode of the light-emitting element EE of the first pixel PA of the first display area DAA, and second sensed data of the second display area DAB may be received from the anode electrode of the light-emitting element EE of the second pixel PB of the second display area DAB.

Although only the first pixel PA of the first display area DAA is illustrated for convenience of explanation, the second pixel PB of the second display area DAB may have a structure substantially the same as a structure of the first pixel PA of the first display area DAA.

The first pixel PA may include a first thin film transistor T1 for applying a first power voltage ELVDD to a second node N2 in response to a signal of a first node N1, a second thin film transistor T2 for outputting the first data voltage VDATA to the first node N1 in response to a first signal S1, a third thin film transistor T3 for outputting a signal of the second node N2 to a sensing node in response to a second signal S2, a storage capacitor CS including a first end portion connected to the first node N1, and including a second end portion connected to the second node N2, and the light-emitting element EE including a first electrode connected to the second node N2, and including a second electrode receiving the second power voltage ELVSS.

Herein, the second power voltage ELVSS may be less than the first power voltage ELVDD. For example, the light-emitting element EE may be an organic light-emitting diode. For example, the first electrode of the light-emitting element EE may be an anode electrode. For example, the second electrode of the light-emitting element EE may be a cathode electrode.

The pixel P may further include a switch SW writing a sensing initialization voltage VSEN to the second node N2. The switch SW may be turned on and turned off based on a third signal S3.

For example, the second signal S2 and the third signal S3 are activated in a sensing initialization step so that the sensing initialization voltage VSEN may be applied to the second node N2.

The first data voltage VDATA may be outputted by an amplifier AMP of the first data driver 400A. An analog digital converter ADC is connected to the sensing node. The analog digital converter ADC may convert the signal of the second node N2 to a digital sensed signal to generate sensed data.

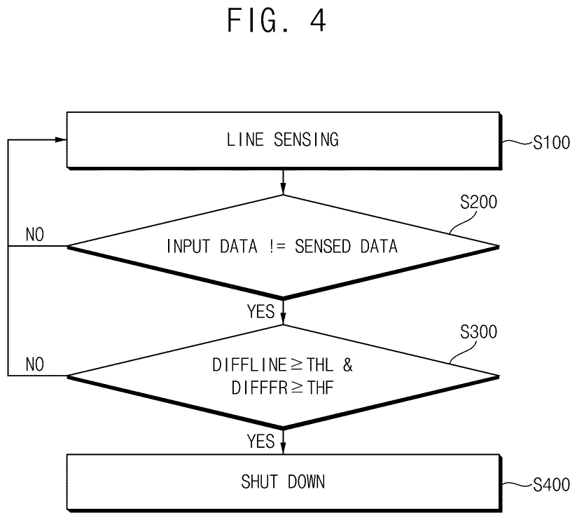

FIG. 3 is a block diagram illustrating the first driving controller 200A of FIG. 1. FIG. 4 is a flowchart illustrating an operation of the first driving controller 200A of FIG. 1.

Referring to FIGS. 1 to 4, at least one of the first driving controller 200A or the second driving controller 200B may compare input data and sensed data, and may generate a shutdown signal SH based on a comparison result of the input data and the sensed data.

The first driving controller 200A may compare the input data and the sensed data and may generate the shutdown signal SH based on the comparison result of the input data and the sensed data.

The second driving controller 200B may output second input data of the second display area DAB to the first driving controller 200A. In addition, the first driving controller 200A may receive second sensed data of the second display area DAB through the second data driver 400B, the first data driver 400A or the second driving controller 200B.

For example, the first driving controller 200A may receive the input data and the sensed data of both of the first display area DAA and the second display area DAB, and may compare the input data and the sensed data of the first display area DAA and the second display area DAB.

The first driving controller 200A may include an input data processor 210A for simplifying the input data LID to generate simplified input data SID, a sensed data processor 220A for simplifying the sensed data LSD to generate simplified sensed data SSD, a first comparator 230A for comparing the simplified input data SID and the simplified sensed data SSD, and a shutdown controller 240A for generating the shutdown signal SH based on the comparison result DIFF of the simplified input data SID and the simplified sensed data SSD.

Herein, each of the input data LID and the sensed data LSD may be data for one horizontal line of the display panel 100. In other words, the sensed data LSD may be generated in a unit of a horizontal line (operation S100).

At least one of the input data processor 210A and the sensed data processor 220A may operate data conversion to unify formats of the input data LID and the sensed data LSD. The input data LID may be data in a grayscale domain and the sensed data LSD may be data in a current domain, a voltage domain, or a luminance domain. Thus, at least one of the input data processor 210A or the sensed data processor 220A may operate the data conversion to unify the formats of the input data LID and the sensed data LSD.

The shutdown controller 240A may determine an activation of the shutdown signal SH based on a difference DIFF between the simplified input data SID and the simplified sensed data SSD for an N-th horizontal line (operation S200).

For example, each of the simplified input data SID and the simplified sensed data SSD may have values for respective pixels. When a horizontal resolution is 3000, the simplified input data SID may have 3000 values for 3000 pixels, and the simplified sensed data SSD may have 3000 values for 3000 pixels.

For example, the shutdown controller 240A may determine whether the number of pixels, in which the difference DIFF between the simplified input data SID and the simplified sensed data SSD is equal to or greater than a threshold value, is equal to or greater than a threshold pixel number for the N-th horizontal line (operation S300).

The pixel in which the difference DIFF between the simplified input data SID and the simplified sensed data SSD equal to or greater than the threshold value may mean that the pixel is a suspicious pixel (e.g., a potentially defective pixel) that may have an error due to the difference between the value of the simplified input data SID and the value of the simplified sensing data SSD being quite great.

When the number of the suspicious pixels of having an error is equal to or greater than the threshold pixel number for the N-th horizontal line, the N-th horizontal line may be a suspicious line (e.g., a potentially defective line) that may have an error. For example, when the number of pixels, in which the difference DIFF

between the simplified input data SID and the simplified sensed data SSD is equal to or greater than the threshold value, is equal to or greater than the threshold pixel number for the N-th horizontal line, then the shutdown controller 240A may determine the N-th horizontal line as an error line. In addition, when the number DIFFLINE of the error lines is equal to or greater than a threshold line number THL, the shutdown signal SH may be activated (operation S300). The number DIFFLINE of the error lines being equal to or greater than the threshold line number THL may mean that an error area is equal to or greater than a corresponding area (e.g., a predetermined area).

For example, when the number of pixels in which the difference DIFF between the simplified input data SID and the simplified sensed data SSD is equal to or greater than the threshold value is equal to or greater than the threshold pixel number for the N-th horizontal line, the shutdown controller 240A may determine the N-th horizontal line as the error line. In addition, when the number DIFFFR of frames, in which the N-th horizontal line is determined as the error line, is equal to or greater than a threshold frame number THF, the shutdown controller 240A may activate the shutdown signal SH (operation S300). The number DIFFFR of the frames in which the N-th horizontal line is determined as the error line being equal to or greater than the threshold line number THL may mean that an error occurrence time is equal to or greater than a corresponding time (e.g., predetermined time).

For example, when the number of frames DIFFFR in which the number DIFFLINE of the error lines is equal to or greater than the threshold line number THL is equal to or greater than the threshold frame number THF, the shutdown controller 240A may activate the shutdown signal SH (operation S300). The number of frames DIFFFR in which the number DIFFLINE of the error lines is equal to or greater than the threshold line number THL being equal to or greater than the threshold frame number THF may mean that the error area is equal to or greater than the corresponding area and the error occurrence time is equal to or greater than the corresponding time.

When the power voltage generator 500 receives the activated shutdown signal SH, the power voltage generator 500 may not output the first power voltage ELVDD or may change a level of the first power voltage ELVDD (operation S400).

A method of shutting down the image display of the display panel 100 may not be limited thereto. Alternatively, when the power voltage generator 500 receives the activated shutdown signal SH, the power voltage generator 500 may not output a data power voltage to the first data driver 400A and the second data driver 400B or may change a level of the data power voltage.

Alternatively, the shutdown signal SH may be outputted to the first data driver 400A and the second data driver 400B. For example, when the first data driver 400A and the second data driver 400B receive the activated shutdown signal SH, an output of the first data driver 400A and an output of the second data driver 400B may be blocked. Alternatively, when the first data driver 400A and the second data driver 400B receive the activated shutdown signal SH, the first data driver 400A and the second data driver 400B may output data voltages corresponding to a black image to the display panel 100.

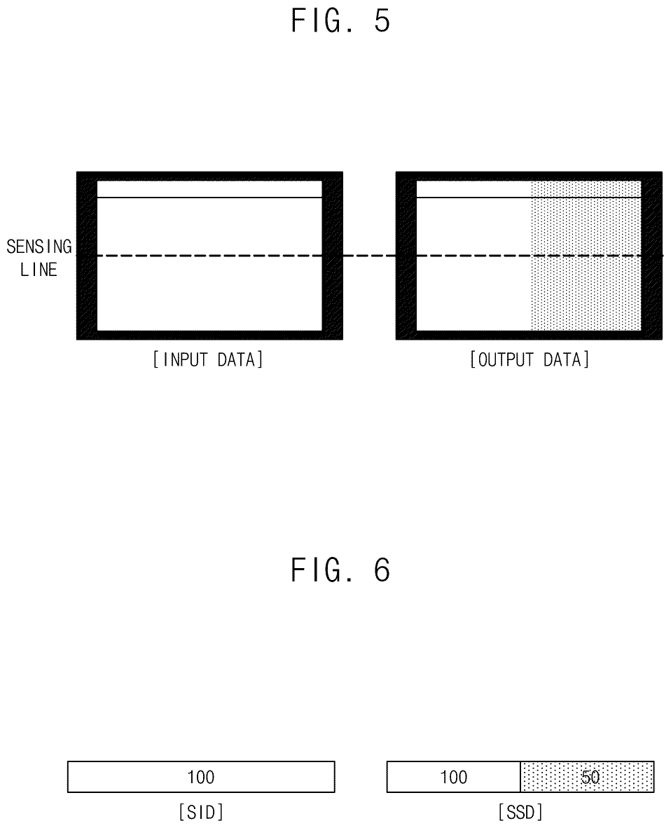

FIG. 5 is a diagram illustrating a case in which a luminance change error occurs in the display panel 100 of FIG. 1. FIG. 6 is a diagram illustrating the simplified input data SID and the simplified sensed data SSD generated by the first driving controller 200A of FIG. 3 in the case of FIG. 5.

FIG. 5 illustrates a case in which a luminance change occurs in the second display area DAB due to an error of the second driving controller 200B.

In the input data of FIG. 5, the image of the first display area DAA and the image of the second display area DAB are normal. However, in the output data of FIG. 5, the image of the first display area DAA is normal, but the luminance of the image of the second display area DAB is abnormally decreased.

As shown in FIG. 6, the simplified input data SID have a value of 100 for the first display area DAA and have a value of 100 for the second display area DAB corresponding to the sensing line. In contrast, the simplified sensed data SSD have a value of 100 for the first display area DAA but have a value of 50 for the second display area DAB corresponding to the sensing line.

When the luminance change error of FIG. 5 occurs, the first driving controller 200A may monitor the luminance change error and activate the shutdown signal SH.

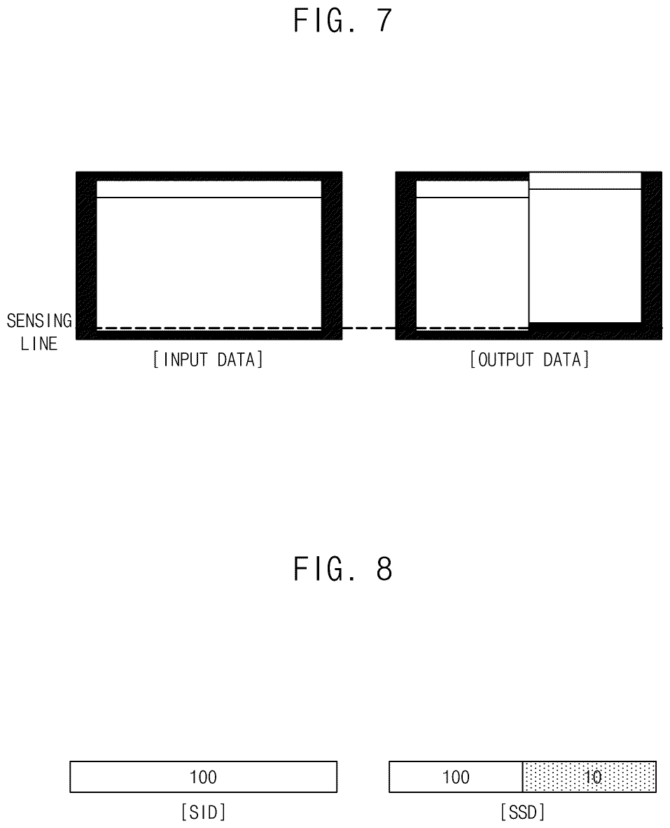

FIG. 7 is a diagram illustrating a case in which a vertical shift error occurs in the display panel 100 of FIG. 1. FIG. 8 is a diagram illustrating simplified input data SID and simplified sensed data SSD generated by the first driving controller 200A of FIG. 3 in the case of FIG. 7.

FIG. 7 illustrates a case in which an image is vertically shifted in the second display area DAB due to an error of the second driving controller 200B.

In the input data of FIG. 7, the image of the first display area DAA and the image of the second display area DAB are normal. However, in the output data of FIG. 7, the image of the first display area DAA is normal, but the image of the second display area DAB is vertically shifted abnormally.

As shown in FIG. 8, the simplified input data SID have a value of 100 for the first display area DAA and have a value of 100 for the second display area DAB corresponding to the sensing line. In contrast, the simplified sensed data SSD have a value of 100 for the first display area DAA, but have a value of 10 for the second display area DAB corresponding to the sensing line.

When the vertical shift error of FIG. 7 occurs, the first driving controller 200A may monitor the vertical shift error, and may activate the shutdown signal SH.

To monitor the vertical shift error well, the sensed data may be sensed from an upper end portion of the display panel 100 or from a lower end portion of the display panel 100.

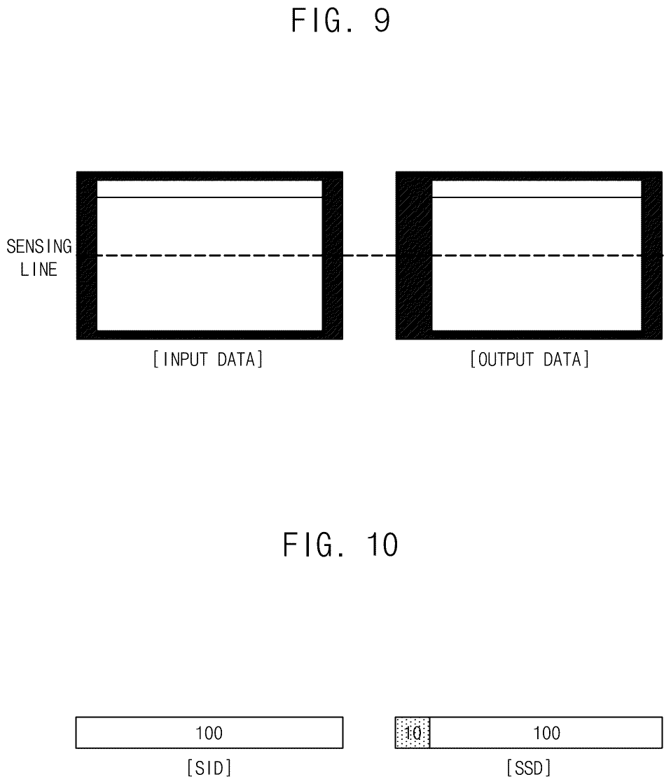

FIG. 9 is a diagram illustrating a case in which a horizontal shift error occurs in the display panel 100 of FIG. 1. FIG. 10 is a diagram illustrating simplified input data SID and simplified sensed data SSD generated by the first driving controller 200A of FIG. 3 in the case of FIG. 9.

FIG. 9 illustrates a case in which an image is horizontally shifted in the first display area DAA due to an error of the first driving controller 200A.

In the input data of FIG. 9, the image of the first display area DAA and the image of the second display area DAB are normal. However, in the output data of FIG. 9, the image of the second display area DAB is normal but the image of the first display area DAA is horizontally shifted abnormally.

As shown in FIG. 10, the simplified input data SID have a value of 100 for the first display area DAA, and have a value of 100 for the second display area DAB corresponding to the sensing line. In contrast, the simplified sensed data SSD have a value of 10 for a partial area on a left side of the first display area DAA, and have a value of 100 for a remaining area corresponding to the sensing line.

When the horizontal shift error of FIG. 9 occurs, the first driving controller 200A may monitor the horizontal shift error, and may activate the shutdown signal SH.

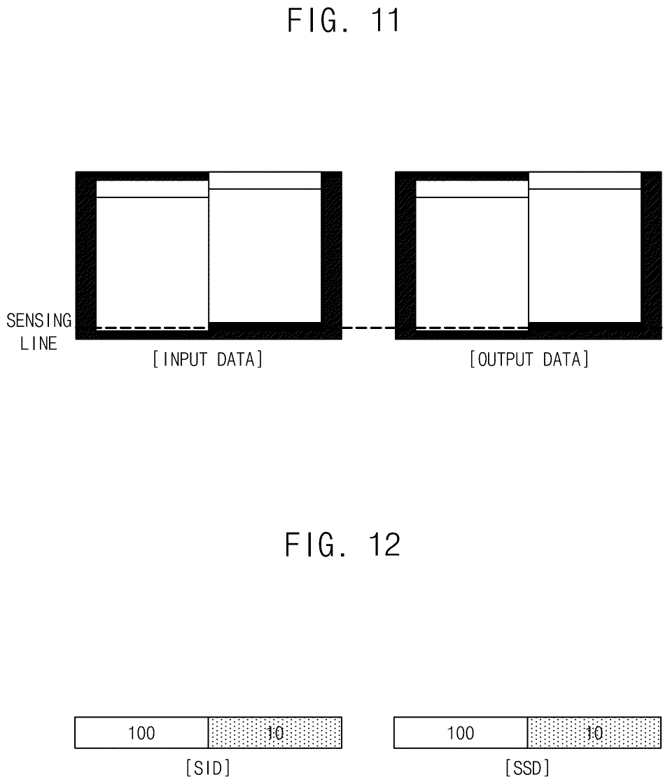

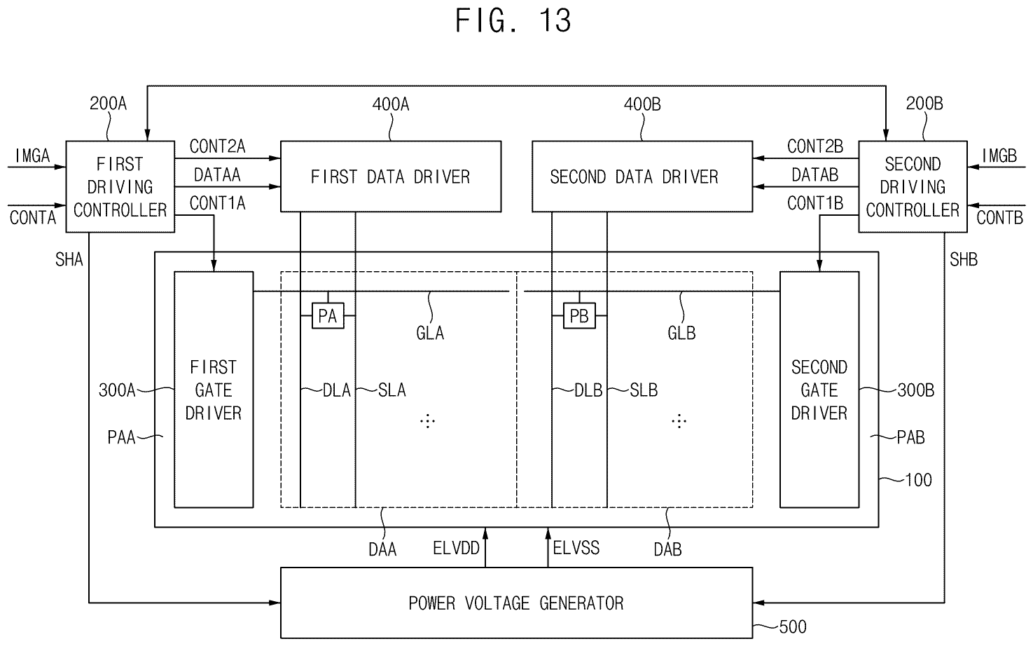

FIG. 11 is a diagram illustrating a case in which an error does not occur in the display panel 100 of FIG. 1. FIG. 12 is a diagram illustrating simplified input data SID and simplified sensed data SSD generated by the first driving controller 200A of FIG. 3 in the case of FIG. 11.

FIG. 11 illustrates a case in which an input image similar to the vertical shift error in FIG. 7 is input, but is not actually a vertical shift error but a normal image without an error.

As shown in FIG. 12, the simplified input data SID have a value of 100 for the first display area DAA, and have a value of 10 for the second display area DAB corresponding to the sensing line. Likewise, the simplified sensed data SSD have a value of 100 for the first display area DAA, and have a value of 10 for the second display area DAB corresponding to the sensing line.

The case of FIG. 11 looks like the vertical shift error but the case does not have the vertical shift error so that the first driving controller 200A may monitor the “no error” status, and may not activate the shutdown signal SH.

The display image abnormality may be properly monitored by comparing the input data and the sensed data in the display apparatus including the plurality of driving controllers 200A and 200B.

When the display image abnormality occurs in the display apparatus including the plurality of driving controllers 200A and 200B, the image display of the display panel 100 may be stopped so that the reliability of the display apparatus may be enhanced.

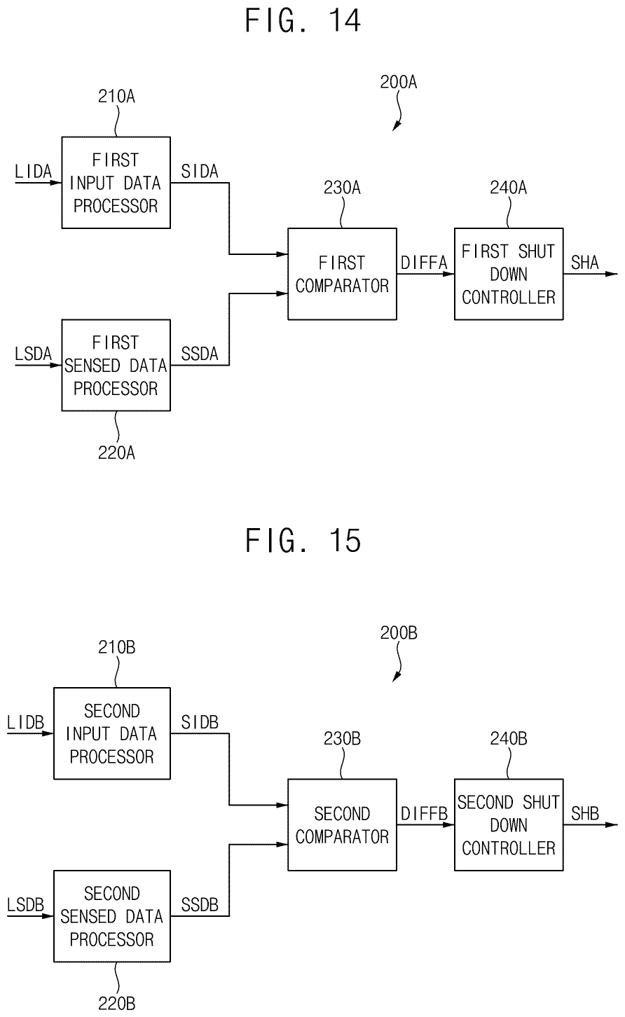

FIG. 13 is a block diagram illustrating a display apparatus according to one or more embodiments of the present disclosure. FIG. 14 is a block diagram illustrating a first driving controller 200A of FIG. 13. FIG. 15 is a block diagram illustrating a second driving controller 200B of FIG. 13.

The display apparatus is substantially the same as the display apparatus of the one or more embodiments previously explained referring to FIGS. 1 to 12 except that a first driving controller 200A generates a first shutdown signal SHA and that a second driving controller 200B generates a second shutdown signal SHB. Thus, the same reference numerals will be used to refer to the same or like parts as those described in the one or more previous embodiments corresponding to FIGS. 1 to 12 and any repetitive explanation concerning the above elements will be omitted.

Referring to FIGS. 1, 2, and 4 to 15, the first driving controller 200A may compare first input data and first sensed data, which correspond to a first display area DAA, and may generate a first shutdown signal SHA based on a comparison result of the first input data and the first sensed data.

The second driving controller 200B may compare second input data and second sensed data, which correspond to a second display area DAB, and may generate a second shutdown signal SHB based on a comparison result of the second input data and the second sensed data.

For example, the first driving controller 200A may include a first input data processor 210A for simplifying the first input data LIDA of the first display area DAA to generate first simplified input data SIDA, a first sensed data processor 220A for simplifying the first sensed data LSDA of the first display area DAA to generate first simplified sensed data SSDA, a first comparator 230A for comparing the first simplified input data SIDA and the first simplified sensed data SSDA, and a first shutdown controller 240A for generating the first shutdown signal SHA based on the comparison result DIFFA of the first simplified input data SIDA and the first simplified sensed data SSDA.

For example, the second driving controller 200B may include a second input data processor 210B for simplifying the second input data LIDB of the second display area DAB to generate second simplified input data SIDB, a second sensed data processor 220B for simplifying the second sensed data LSDB of the second display area DAB to generate second simplified sensed data SSDB, a second comparator 230B for comparing the second simplified input data SIDB and the second simplified sensed data SSDB, and a second shutdown controller 240B for generating the second shutdown signal SHB based on the comparison result DIFFB of the second simplified input data SIDB and the second simplified sensed data SSDB.

When the power voltage generator 500 receives at least one of the activated first shutdown signal SHA or the activated second shutdown signal SHB, the power voltage generator 500 may not output the first power voltage ELVDD, or may change a level of the first power voltage ELVDD.

The display image abnormality may be properly monitored by comparing the input data and the sensed data in the display apparatus including the plurality of driving controllers 200A and 200B.

When the display image abnormality occurs in the display apparatus including the plurality of driving controllers 200A and 200B, the image display of the display panel 100 may be stopped so that the reliability of the display apparatus may be enhanced.

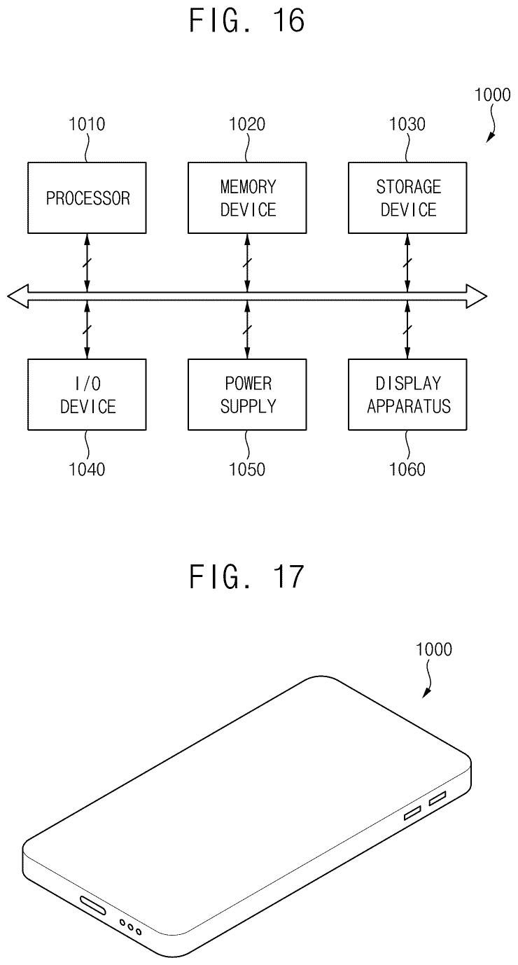

FIG. 16 is a block diagram illustrating an electronic apparatus (e.g., electronic device) 1000 according to one or more embodiments of the present disclosure. FIG. 17 is a diagram illustrating an example in which the electronic apparatus 1000 of FIG. 16 is implemented as a smartphone.

Referring to FIGS. 16 and 17, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, etc.

In one or more embodiments, as illustrated in FIG. 17, the electronic apparatus 1000 may be implemented as a smartphone. However, the electronic apparatus 1000 is not limited thereto. For example, the electronic apparatus 1000 may be implemented as a television, a monitor, a cellular phone, a video phone, a smart pad, a smart watch, a tablet PC, a car navigation system, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the first driving controller 200A and 200B of FIG. 1.

The memory device 1020 may store data for operations of the electronic apparatus 1000. For example, the memory device 1020 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and/or the like and/or at least one volatile memory device such as a dynamic random access memory (DRAM) device, a static random access memory (SRAM) device, a mobile DRAM device, and/or the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

The electronic apparatus 1000 according to one or more embodiments is a device that displays a moving image and/or a still image. A display device of the electronic device may be applied to portable electronic devices, such as mobile phones, smartphones, tablet personal computers (PCs), mobile communication terminals, electronic notebooks, electronic books, portable multimedia players (PMPs), navigations, and ultra-mobile PCs (UMPCs). For example, the display device may be applied to a display unit of a television, a laptop computer, a monitor, a billboard, or the Internet of Things (IoT). Alternatively, in one or more embodiments, the display device may be applied to a smartwatch, a watch phone, and/or a head-mounted display device (HMD) for implementing virtual reality and/or augmented reality.

According to the embodiments of the display apparatus and the method of driving the display panel using the display apparatus, the display image abnormality may be monitored in the display apparatus including the plurality of driving controllers.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A display apparatus comprising:
a display panel comprising a first display area and a second display area;
a first gate driver configured to output a first gate signal to the first display area;
a first data driver configured to output a first data voltage to the first display area;
a first driving controller configured to control the first gate driver and the first data driver;
a second gate driver configured to output a second gate signal to the second display area;
a second data driver configured to output a second data voltage to the second display area; and
a second driving controller configured to control the second gate driver and the second data driver,
wherein at least one of the first driving controller or the second driving controller is configured to compare input data and sensed data, and to generate a shutdown signal based on a comparison result of the input data and the sensed data.

2. The display apparatus of claim 1, wherein the sensed data corresponds to an anode electrode of a light-emitting element of a pixel of the display panel.

3. The display apparatus of claim 2, wherein the pixel comprises:
a first thin film transistor configured to apply a first power voltage to a second node in response to a signal of a first node;
a second thin film transistor configured to output a data voltage to the first node in response to a first signal;
a third thin film transistor configured to output a signal of the second node to a sensing node in response to a second signal;
a storage capacitor comprising a first end portion coupled to the first node, and a second end portion coupled to the second node; and
the light-emitting element comprising the anode electrode coupled to the second node, and a cathode electrode configured to receive a second power voltage.

4. The display apparatus of claim 1, wherein the second driving controller is configured to output second input data of the second display area to the first driving controller.

5. The display apparatus of claim 4, wherein the first driving controller comprises:
an input data processor configured to simplify the input data to generate simplified input data;
a sensed data processor configured to simplify the sensed data to generate simplified sensed data;
a comparator configured to compare the simplified input data and the simplified sensed data; and
a shutdown controller configured to generate the shutdown signal based on a comparison result of the simplified input data and the simplified sensed data.

6. The display apparatus of claim 5, wherein at least one of the input data processor or the sensed data processor is configured to perform data conversion to unify formats of the input data and the sensed data.

7. The display apparatus of claim 5, wherein the shutdown controller is configured to determine whether a number of pixels, in which a difference between the simplified input data and the simplified sensed data is equal to or greater than a threshold value, is equal to or greater than a threshold pixel number for an N-th horizontal line, N being a positive integer.

8. The display apparatus of claim 7, wherein the shutdown controller is configured to determine the N-th horizontal line as an error line when the number of the pixels is equal to or greater than the threshold pixel number for the N-th horizontal line, and
wherein the shutdown signal is configured to be activated when a number of the error lines is equal to or greater than a threshold line number.

9. The display apparatus of claim 7, wherein the shutdown controller is configured to determine the N-th horizontal line as an error line when the number of the pixels is equal to or greater than the threshold pixel number for the N-th horizontal line, and
wherein the shutdown signal is configured to be activated when a number of frames in which the N-th horizontal line is determined as the error line is equal to or greater than a threshold frame number.

10. The display apparatus of claim 7, wherein the shutdown controller is configured to determine the N-th horizontal line as an error line when the number of the pixels is equal to or greater than the threshold pixel number for the N-th horizontal line, and
wherein the shutdown signal is configured to be activated when a number of frames, in which a number of the error lines is equal to or greater than a threshold line number, is equal to or greater than a threshold frame number.

11. The display apparatus of claim 1, wherein the sensed data are configured to be generated in a unit of a horizontal line, and
wherein the sensed data are configured to be sensed from an upper end portion of the display panel or from a lower end portion of the display panel.

12. The display apparatus of claim 1, further comprising a power voltage generator configured to output a first power voltage to the display panel,
wherein the power voltage generator is configured not to output the first power voltage, or is configured to change a level of the first power voltage, based on receiving the shutdown signal that is activated.

13. The display apparatus of claim 1, wherein the first driving controller comprises:
a first input data processor configured to simplify first input data of the first display area to generate first simplified input data;
a first sensed data processor configured to simplify first sensed data of the first display area to generate first simplified sensed data;
a first comparator configured to compare the first simplified input data and the first simplified sensed data; and
a first shutdown controller configured to generate a first shutdown signal based on a comparison result of the first simplified input data and the first simplified sensed data.

14. The display apparatus of claim 13, wherein the second driving controller comprises:
a second input data processor configured to simplify second input data of the second display area to generate second simplified input data;
a second sensed data processor configured to simplify second sensed data of the second display area to generate second simplified sensed data;
a second comparator configured to compare the second simplified input data and the second simplified sensed data; and
a second shutdown controller configured to generate a second shutdown signal based on a comparison result of the second simplified input data and the second simplified sensed data.

15. The display apparatus of claim 14, further comprising a power voltage generator configured to output a first power voltage to the display panel,
wherein the power voltage generator is configured not to output the first power voltage, or is configured to change a level of the first power voltage, based on receiving at least one of the first shutdown signal that is activated or the second shutdown signal that is activated.

16. A method of driving a display panel, the method comprising:
outputting a first gate signal to a first display area of the display panel;
outputting a first data voltage to the first display area;
outputting a second gate signal to a second display area of the display panel;
outputting a second data voltage to the second display area;
sensing output data of the display panel;
comparing input data and sensed data using at least one of a first driving controller controlling driving of the first display area or a second driving controller controlling driving of the second display area; and
generating a shutdown signal based on a comparison result of the input data and the sensed data.

17. The method of claim 16, further comprising:
simplifying the input data to generate simplified input data;
simplifying the sensed data to generate simplified sensed data;
comparing the simplified input data and the simplified sensed data; and
generating the shutdown signal based on a comparison result of the simplified input data and the simplified sensed data.

18. The method of claim 17, wherein comparing the input data and the sensed data comprises determining whether a number of pixels, in which a difference between the simplified input data and the simplified sensed data is equal to or greater than a threshold value, is equal to or greater than a threshold pixel number for an N-th horizontal line, N being a positive integer.

19. The method of claim 18, further comprising determining the N-th horizontal line as an error line when the number of the pixels is equal to or greater than the threshold pixel number for the N-th horizontal line; and
activating the shutdown signal when a number of the error lines is equal to or greater than a threshold line number.

20. The method of claim 18, further comprising determining the N-th horizontal line as an error line when the number of the pixels is equal to or greater than the threshold pixel number for the N-th horizontal line; and
activating the shutdown signal when a number of frames in which the N-th horizontal line is determined as the error line is equal to or greater than a threshold frame number.

21. An electronic device comprising a display apparatus comprising:
a display panel comprising a first display area and a second display area;
a first gate driver configured to output a first gate signal to the first display area;
a first data driver configured to output a first data voltage to the first display area;
a first driving controller configured to control the first gate driver and the first data driver;
a second gate driver configured to output a second gate signal to the second display area;
a second data driver configured to output a second data voltage to the second display area; and
a second driving controller configured to control the second gate driver and the second data driver,
wherein at least one of the first driving controller or the second driving controller is configured to compare input data and sensed data, and to generate a shutdown signal based on a comparison result of the input data and the sensed data.

22. The electronic device of claim 21, wherein the electronic device comprises a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).
